(19) United States
(12) Patent Application Publication
(10) Pub. No.: US 2019/0266651 A1
(43) Pub. Date: Aug. 29, 2019

(54) SYSTEM AND METHOD FOR PROVIDING A PLURALITY OF SERVICE PROVIDERS BASED ON ISSUES RECEIVED FROM A USER OVER NETWORK

(71) Applicant: Bernard Ndolo, Luxembourg (LU)

(72) Inventor: Bernard Ndolo, Luxembourg (LU)

(21) Appl. No.: 15/906,277

(22) Filed: Feb. 27, 2018

(51) Int. Cl. G06Q 30/06; G06Q 10/10

(52) U.S. Cl. CPC G06Q 30/0611; G06Q 10/1097

(57) ABSTRACT

A system and method for providing a plurality of service providers based on the one or more issues received from a user. The method captures one or more issues through a computing device. The computing device captures the issues by recording a video, taking a picture, writing text, and/or voice recording. The captured issues are uploaded over the network. The issues are pertaining to household services, repairing services, construction services, automobile services, business services, renovation services etc. Then the method analyses the uploaded issues and categorizes the uploaded issues into a service category, and/or a plurality of service providers. Further, the method displays the plurality of service providers operating to provide a service related to the issues uploaded by the user. The plurality of service providers is displayed based on a geographical location of the user. Further, the service providers provide a bid offer and service availability schedule to provide the service. Then the user may select the service provider based on the preliminarily bid offer and the possible service availability schedule.

### TECHNICAL FIELD

The present invention relates to an integrated platform for service providers and users, in particular to system and method to provide a plurality of service providers based on the one or more issues received from a user over a network.

### BACKGROUND

Background description includes information that may be useful in understanding the present invention. It is not an admission that any of the information provided herein is prior art or relevant to the presently claimed invention, or that any publication specifically or implicitly referenced is prior art.

The Internet has turned out to be progressively vital to the service providers and product suppliers for providing information related to their services and products. It has likewise turned into an imperative tool for the users searching for a particular service or a product. However, the internet contains an immense amount of information and, in light of the fact that this information is so diverse, the accurate information about the service providers isn't generally effectively found. In view of the increasing amount of data available on the Internet, there is a need for a system and method to provide an efficient mechanism to access and display the information related to the service providers and/or the product suppliers in real-time.

Further, the users who need the services of professional service providers face challenges to find suitable service providers who are most qualified to perform the work and is willing to perform it at competitive charges within an agreed period of time. For example, a user who needs the service of an electrician must actively seek out expertise and information regarding their professional certifications, experience, ability to provide the specific services which are required and the charges they will charge to perform the services. Another example is individuals who are in the need of device repair, home renovation, ironing or other services.

In view of the increasing on-demand services and growth of the gig economy, there is a dire need for a system and method for automatically capturing the issues using a mobile computing device which can be further automatically matched with a suitable service provider who can resolve/offer service of the captured issue effectively. Further, there is also a need for a system and method to automatically identify one or more items and suggest or match the user to the most suitable or preferred service providers and suppliers who may resolve the related issues or supply the requested product. In addition, the system can also learn from previous service requests and automatically suggest or choose a suitable service provider or supplier who successfully provided the service or product.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context.

The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability.

### DISCUSSION OF RELATED ART

A method for routing customer orders, received over the internet, to a service provider such as a print service provider selected from a plurality of competing print service providers, comprises an electronic interface configured to receive and acknowledge customer orders; first processing means configured to compare the requirements of a received order with pre-stored information specific to each of the competing service providers; responsive means configured to establish a list of the service providers determined to be able to fulfil requirements of the received order; and processing means configurable, for a received order, to make the selection from the list and to route the received order to the selected service provider, as disclosed in U.S. Pat. No. 7,225,220 B2 of Manuel Gonzalez, which is incorporated herein by reference. Further, a method and apparatus are for matching ready-to-act consumers and pre-qualified service providers, as disclosed in U.S. Pat. No. 7,096,193 B1 of Michael J. Beaudoin, which is incorporated herein by reference. Furthermore, a method and system for evaluating, analysing, assimilating and collating preferred automobile service stations, service garages and automobile repair shops based on the total cost of service, user ranking, user feedback, earliest available appointment and distance of these vehicle service stations from the user location through a designated website accessible by a user via a communication network such as the internet, as disclosed in US patent application 20090254454 A1 of Mohit Gupta, which is incorporated herein by reference.

However, the patents and patent application mentioned above do not explicitly discuss the application of machine learning to process the captured video file, photo, text, voice or a combination of all 4 formats to identify the issue and accordingly provide a list of service providers. Additionally, the existing arts are not using artificial intelligence to understand the previously captured/recorded issues and further use that knowledge to efficiently process future similar requests to resolve the similar issues. Further, the patent literature mentioned above also do not talk about a software application that can automatically detect/identify the target device or equipment and the corresponding issues. Further, the patent literature mentioned do not talk about using an on-demand cloud-based platform provided by commercial organizations. The present invention enables the user to automatically upload the recorded or documented videos, captured photos, voice recording, and texts to a plurality of cloud-based platforms. Examples of the cloud-based platforms including but not limited to Amazon™ Web Services (AWS), Google™ Cloud Platform (GCP), HP™ Cloud, IBM™, Microsoft Azure™, Oracle™, Red Hat™, Salesforce™ VMware™ etc. Typically, cloud-based platforms allow the developers to seamlessly deploy the software applications in the cloud, or use services provided from the cloud, or both. The cloud-based platform provided by the present invention is accessible to the service providers and the product suppliers. Further, the cloud-based platform provided by the present invention enables the service providers are to view and analyze the problem and provide price quotations and availability schedules to the user. Additionally, the present invention enables a user to capture the issues in a live video format and process the captured issues by using automatic image recognition and machine learning technology.

### SUMMARY

The present invention mainly solves the technical problems existing in the prior art. In response to these problems, the present invention provides a system and method that provides a plurality of service providers based on the one or more issues received from a user.

An aspect of the present disclosure relates to a device in a network. The device includes a non-transitory storage device having embodied therein one or more routines operable to provide a plurality of service providers based on the one or more issues received from a user. Examples of the user may include but are not limited to, end user, client, customer, and the consumer who use the present system as a software application to record or document the problems that they are experiencing in the day to day life or services that they may require.

The one or more routines include a computing mobile device, an upload module, an analysis module, a display module, a selection module, a detection module, a first identification module, a second identification module, and a determination module. The computing mobile device is configured to capture one or more issues. The computing mobile device captures the issues by recording a video, taking a picture, writing text, recording speech, automatic image/object recognition or a combination thereof. The one or more issues are pertaining to at least one of a household service, a repairing service, a construction service, an automobile service, a business service, a renovation service and/or a combination thereof. Examples of the computing mobile device may include but are not limited to, a portable device, a wearable device such as tablet computers, mobile phones, smart eyeglasses, personal digital assistant, augmented reality headsets etc. In an aspect, the computing mobile device includes an on-board processing unit, RAM, and storage unit. Further, the computing mobile device includes a camera, microphone, speaker, a plurality of sensors, an OS function, memory, input/output interface etc.

The upload module is configured to upload the captured issues over the network. The one or more issues are pertaining to at least one of a household service, a repairing service, a construction service, an automobile service, a business service, a renovation service and/or a combination thereof. The analysis module is configured to analyze the uploaded issues and further categorize the uploaded issues into a service category, a plurality of service providers and/or a combination thereof. Examples of the service providers may include but are not limited to, an individual, a shopkeeper, a professional, a product supplier, artist, plumber, mechanic, an interior designer etc., who may receive the recorded or documented problems faced by the user over the present system via cloud-based platforms and further resolve those issues/problems.

The display module is configured to display the plurality of service providers operating to provide a service related to the issues uploaded by the user. The plurality of service providers are displayed based on a geographical location of the user, further, the service providers provide a preliminarily bid offer and possible service availability schedules to provide the service.

The selection module is configured to select the service provider based on the preliminarily bid offer and the possible service availability schedule. The detection module is configured to automatically detect one or more items on receiving a pointing gesture from the user through the computing device. The one or more items are selected from at least one of electrical-electronic units, furniture, building infrastructure and/or a combination thereof. The first identification module is configured to identify patterns of issues with a common category or a similar characteristic to accurately display a plurality of service providers on identifying the similar issues in future. The second identification module is configured to identify a plurality of models of the one or more detected items and consequently display a plurality of service providers operating to offer repair or maintenance services of the identified model of the items. The third identification module is configured to identify a plurality of device models of the one or more detected items and consequently display a plurality of suppliers to offer a new or upgrade of the identified device model of the items. The determination module is configured to determine the suppliers and service providers frequently preferred by the user and display the plurality of preferred service providers.

Accordingly, one advantage of the present invention is that it utilizes machine learning and artificial intelligence to understand previously captured issues and problems and using that knowledge to efficiently process future similar requests.

Accordingly, one advantage of the present invention is that it enables the user to capture the issues by recording a video, taking a picture, writing text, recording speech, automatic image/object recognition or a combination thereof. The default means to capture the issue is by recording the video of the issue.

Another advantage of the present invention is that it processes the captured video to automatically match the user to service providers, product suppliers and the service categories. The processing of automatically matching the user to service providers, product suppliers and service categories is processed using the computing mobile device internal processing capabilities and an on-demand cloud computing platform.

Another advantage of the present invention is that it enables a user to capture the issues in a live video format and process the captured issues by using automatic image recognition and machine learning technology.

To undertake the intensive data prepossessing, long-term storage, archival and in-depth processing, another advantage of the present invention is that it can leverage on-demand cloud platforms offered by commercial organisations including, but not limited to Amazon™ Web Services (AWS), Google™ Cloud Platform (GCP), HP™ Cloud, IBM™, Microsoft Azure™, Oracle™, Red Hat™, Salesforce™, VMware™ and etc. The system is cable of accessing the on-demand cloud computing services offered by various service providers via query and federation layers. The system can leverage from on-demand cloud platforms services such as processing of queries, analysis of tasks, deciding which on-demand platform is best placed to hold the needed data and negotiate participation to acquire the data. In addition, real-time or context-aware queries are handled through the federation layer via a sources layer that seamlessly handles the discovery and engagement of data sources. This framework allows a two-way publishing and querying of data. This allows the system respond to the immediate data and processing requests of the end users and provides archival capabilities for later long-term analysis and exploration of value-added trends such as machine learning and artificial intelligence.

To overcome the common challenges of managing fluctuating network bandwidth demands and performance, another advantage of the system is the capability of conducting basic querying and preliminary data processing, short-term storage using the computing mobile device built-in processing module. In addition, the system cable of applying aggregation and fusion techniques which deploy summarization and merging operations in real-time to compress the volume of data to be stored and transmitted to the on-demand cloud computing platform. This reduces the data streaming rates and bottlenecks caused as result of limited bandwidth. To report (and access) data to on-demand cloud platforms, the system can use either a session based synchronisation system or a publisher/subscriber-based system. By using a session-based synchronisation system, data exchange, and store-and-forward mechanisms facilitate the synchronisation of captured data with the on-demand cloud platform. By using the publisher/subscriber system captured data from computing mobile device is delivered to the on-demand cloud platform using notification delivery methods when there is intermittent network connectivity.

To avoid or minimise the system from being used to capture inappropriate video, text, voice or images from users who wish to use the system for nefarious purposes, the present invention can detect and automatically flag inappropriate video, text, voice, and images for further scrutiny by the system support team. Using machine learning and artificial intelligence, the system automatically detects and prevents future uploads of similar inappropriate content from being processed by the system. An example of an inappropriate content includes but not limited to content would be of a user recording private parts of their or other person's body.

An aspect of the present disclosure relates to a system to provide a plurality of service providers based on the one or more issues received from a user. The system includes a processor and a memory. The memory stores machine-readable instructions that when executed by the processor cause the processor to capture the one or more issues through a computing device. In an aspect, the computing device captures the issues by at least one of recording a video, taking a picture, writing text, voice recording, and/or a combination thereof.

The processor is then configured to upload the captured issues over the network. In an aspect, the one or more issues are pertaining to at least one of a household service, a repairing service, a construction service, an automobile service, a business service, a renovation service and/or a combination thereof. The processor is configured to analyze the uploaded issues and further categorize the uploaded issues into a service category, a plurality of service providers and/or a combination thereof;

Further, the processor is configured to display the plurality of service providers operating to provide a service related to the issues uploaded by the user. In an aspect, the plurality of service providers are displayed based on a geographical location of the user, further, the service providers provide a bid offer and service availability schedule to provide the service. The processor is configured to select the service provider based on the preliminarily bid offer and the possible service availability schedule.

The processor is further configured to detect one or more items on receiving a pointing gesture from the user through the computing device. In an aspect, the one or more items are selected from at least one of electrical-electronic units, furniture, building infrastructure and/or a combination thereof.

The processor is further configured to identify patterns of issues with a common category or a similar characteristic to accurately display a plurality of service providers on identifying the similar issues in future. The processor is further configured to identify a plurality of models of the one or more detected items and consequently display a plurality of service providers operating to offer repair or maintenance services of the identified model of the items. The processor is further configured to determine the service providers frequently preferred by the user and display the plurality of preferred service providers.

An aspect of the present disclosure relates to a method for providing a plurality of service providers based on the one or more issues received from a user. The method includes the step of capturing data related to one or more issues through a computing device. The computing device captures the issues by at least one of recording a video, taking a picture, writing text, voice recording, and/or a combination thereof. Then the method includes the step of uploading, by one or more processors, the captured issues over the network. The one or more issues are pertaining to at least one of a household service, a repairing service, a construction service, an automobile service, a business service, a renovation service and/or a combination thereof.

The method then includes the step of analyzing, by one or more processors, the uploaded issues and further categorize the uploaded issues into a service category, a plurality of service providers and/or a combination thereof. Further, the method includes the step of displaying, by one or more processors, the plurality of service providers operating to provide a service related to the issues uploaded by the user. The plurality of service providers are displayed based on a geographical location of the user, further, the service providers offer a preliminarily bid offer and service availability schedule to provide the service. The method includes the step of selecting, by one or more processors, the service provider based on the preliminarily bid offer and the possible service availability schedule.

The method further comprises the step of detecting, by one or more processors, one or more items on receiving a pointing gesture from the user through the computing device. The one or more items are selected from at least one of electrical-electronic units, furniture, building infrastructure and/or a combination thereof.

The method then comprises the step of identifying, by one or more processors, patterns of issues with a common category or a similar characteristic to accurately display a plurality of service providers on identifying the similar issues in future. The method further comprises the step of identifying, by one or more processors, a plurality of models of the one or more detected items and consequently display a plurality of service providers operating to offer repair or maintenance services of the identified model of the items. The method further comprises the step of determining, by one or more processors, the service providers frequently preferred by the user and display the plurality of preferred service providers.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a network implementation of the present system and method to provide a plurality of service providers based on the one or more issues received from a user, in accordance with an embodiment of the present subject matter.

FIG. 2 illustrates the proposed system to provide a plurality of service providers based on the one or more issues received from a user over a network, in accordance with an embodiment of the present subject matter.

FIG. 3 illustrates a flowchart of the method for providing a plurality of service providers based on the one or more issues received from a user over a network, in accordance with at least one embodiment.

FIG. 4 illustrates an exemplary operational block diagram of the present system and method, in accordance with at least one embodiment.

### DETAILED DESCRIPTION

Systems and methods are disclosed for providing a plurality of service providers based on the one or more issues received from a user over a network. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of providing a plurality of service providers based on the one or more issues received from a user over a network, it should be appreciated that the same has been done merely to illustrate the invention in an exemplary manner and any other purpose or function for which explained structures or configurations can be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored and that does not include carrier waves and/or transitory electronic signals propagating wirelessly or over wired connections. Examples of a non-transitory medium may include but are not limited to, a magnetic disk or tape, optical storage media such as compact disk (CD) or digital versatile disk (DVD), flash memory, memory or memory devices.

A computer program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer program product) may be stored in a machine-readable medium. A processor(s) may perform the necessary tasks.

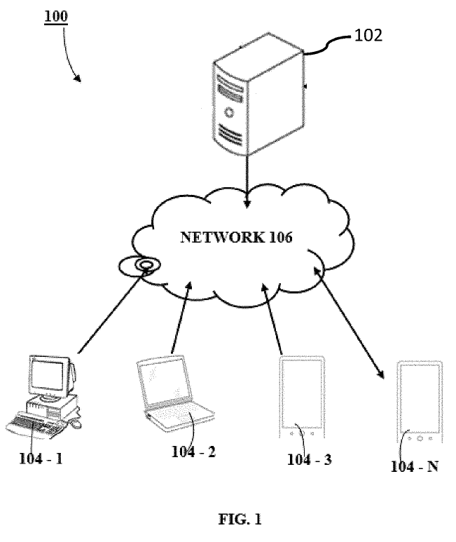

FIG. 1 illustrates a network implementation 100 of the present system and method to provide a plurality of service providers based on the one or more issues received from a user, in accordance with an embodiment of the present subject matter. Although the present subject matter is explained considering that the present system 102 is implemented on a server, it may be understood that the present system 102 may also be implemented in a variety of computing systems, such as a laptop computer, a desktop computer, a notebook, a workstation, a mainframe computer, a server, a network server, and the like. It will be understood that the present system 102 may be accessed by multiple users through one or more computing devices 104-1, 104-2 . . . 104-N, collectively referred to as computing device 104 hereinafter, or applications residing on the computer devices 104. Examples of the computing devices 104 may include but are not limited to, a portable computer, a personal digital assistant, a handheld device, and a workstation. The computing devices 104 are communicatively coupled to the present system 102 through a network 106 and utilizes the various operating system to perform the functions of the present system 102 such Android, IOS, Windows etc.

In one implementation, the network 106 may be a wireless network, a wired network or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

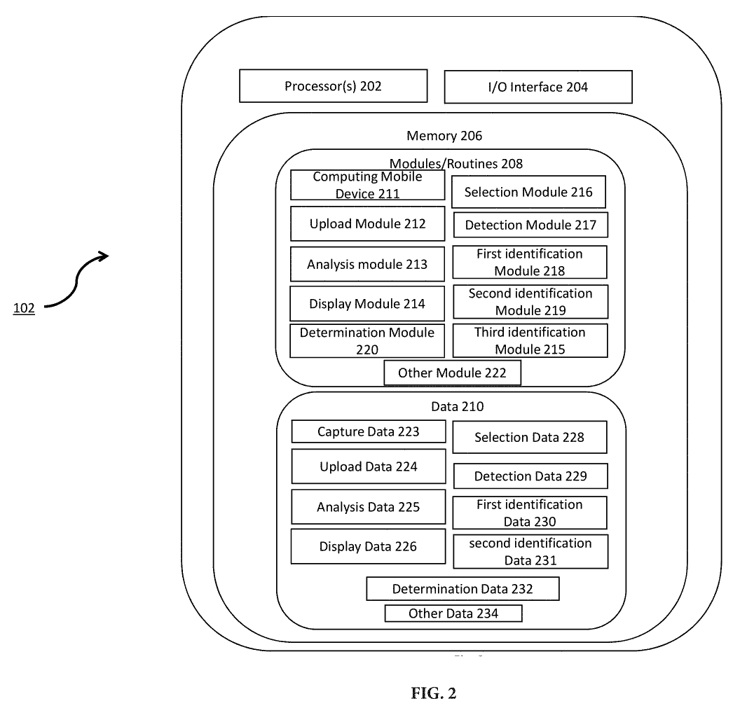

FIG. 2 illustrates the proposed system 102 to provide a plurality of service providers based on the one or more issues received from a user, in accordance with an embodiment of the present subject matter. Referring now to FIG. 2, the system 102 is illustrated in accordance with an embodiment of the present subject matter. In one embodiment, the system 102 may include at least one processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the computing devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a computing mobile device 211, an upload module 212, an analysis module 213, a display module 214, a selection module 216, a detection module 217, a first identification module 218, a second identification module 219, a third identification module 215, a determination module 220 and other modules 222. The other modules 222 may include programs or coded instructions that supplement applications and functions of the system 102.

The data 210, amongst other things, serves as a repository for storing data processed, received, and generated by one or more of the modules 208. The data 210 may also include a capture data 223, an upload data 224, an analysis data 225, a display data 226, a selection data 228, a detection data 229, a first identification data 230, a second identification data 231, a determination data 232 and other data 234. The other data 234 may include data generated as a result of the execution of one or more modules in the other module 222.

In one implementation, the computing mobile device 211 is configured to capture the one or more issues. The computing mobile device 211 captures the issues by recording video, capturing a photo, receiving text, recording voice or a combination of all 4 formats to identify the issue and accordingly provide a list of service providers. The upload module 212 is configured to upload the captured issues over the network 106. The one or more issues are pertaining to at least one of a household service, a repairing service, a construction service, an automobile service, a business service, a renovation service and/or a combination thereof.

The analysis module 213 is configured to analyze the uploaded issues and further categorize the uploaded issues into a service category, a plurality of service providers and/or a combination thereof. The display module 214 is configured to display the plurality of service providers operating to provide a service related to the issues uploaded by the user. The plurality of service providers are displayed based on a geographical location of the user, further, the service providers provide a bid offer and service availability schedule to provide the service. The selection module 216 is configured to select the service provider based on the preliminarily bid offer and the possible service availability schedule.

The detection module 217 is configured to detect one or more items on receiving a pointing gesture from the user through the computing device 104. The one or more items are selected from at least one of electrical-electronic units, furniture, building infrastructure and/or a combination thereof. The first identification module 218 is configured to identify patterns of issues with a common category or a similar characteristic to accurately display a plurality of service providers on identifying the similar issues in future.

The second identification module 219 is configured to identify a plurality of models of the one or more detected items and consequently display a plurality of service providers operating to offer repair or maintenance services of the identified model of the items. The third identification module 215 is configured to identify a plurality of device models of the one or more detected items and consequently display a plurality of suppliers to offer a new or upgrade of the identified device model of the items. The determination module 220 is configured to determine the service providers and suppliers frequently preferred by the user and display the plurality of preferred service providers.

As used herein, and unless the context dictates otherwise, the term “configured to” or “coupled to” is intended to include both direct coupling (in which two elements that are coupled to each other contact each other) and indirect coupling (in which at least one additional element is located between the two elements). Therefore, the terms “configured to”, “configured with”, “coupled to” and “coupled with” are used synonymously. Within the context of this document terms “configured to”, “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

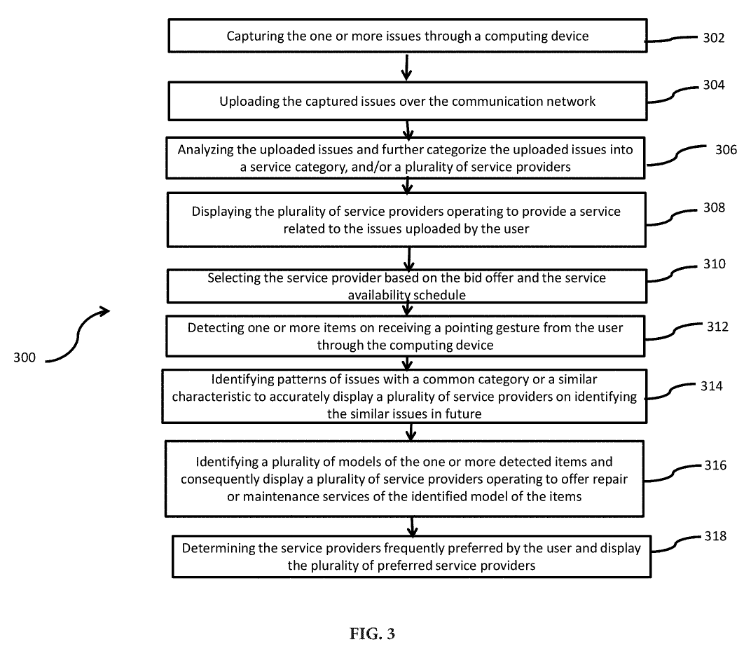

FIG. 3 illustrates a flowchart 300 of the method for providing a plurality of service providers based on the one or more issues received from a user, in accordance with at least one embodiment. The method initiates with the step 302 of capturing, by one or more processors, the one or more issues through a computing device 104. The computing device 104 captures the issues by at least one of recording a video, taking a picture, writing text, voice recording, and/or a combination thereof. Then the method includes the step 304 of uploading, by one or more processors, the captured issues over the network. The one or more issues are pertaining to at least one of a household service, a repairing service, a construction service, an automobile service, a business service, a renovation service and/or a combination thereof.

The method then includes the step 306 of analyzing, by one or more processors, the uploaded issues and further categorize the uploaded issues into a service category, a plurality of service providers and/or a combination thereof. Further, the method includes the step 308 of displaying, by one or more processors, the plurality of service providers operating to provide a service related to the issues uploaded by the user. The plurality of service providers are displayed based on a geographical location of the user, further, the service providers provide a bid offer and service availability schedule to provide the service.

The method includes the step 310 of selecting, by one or more processors, the service provider based on the preliminarily bid offer and the service availability schedule. The method further comprises the step 312 of detecting, by one or more processors, one or more items on receiving a pointing gesture from the user through the computing device. The one or more items are selected from at least one of electrical-electronic units, furniture, building infrastructure and/or a combination thereof.

The method then comprises the step 314 of identifying, by one or more processors, patterns of issues with a common category or a similar characteristic to accurately display a plurality of service providers on identifying the similar issues in future. The method further comprises the step 316 of identifying, by one or more processors, a plurality of models of the one or more detected items and consequently display a plurality of service providers operating to offer repair or maintenance services of the identified model of the items. The method further comprises the step 318 of determining, by one or more processors, the service providers frequently preferred by the user and display the plurality of preferred service providers.

In operation, the present system and method enable the users to document or capture the problems that they are experiencing or services that they require. The present system and method offer them at least four methods of documenting the problems and services required such as recording a video, taking photos, writing text, voice recording or a combination of all 4 formats using the computing device 104 which also includes smart eyeglass with an inbuilt camera, microphone, keyboard etc.

Then the present system and method enable the user to automatically upload/transmit the documented videos, photos, voice recordings and text are automatically to a cloud-based portal. Once the user/consumer has documented the problem using the present system, the system provides the user with a listing of service providers that can provide the service to a user who has requested the service. In an embodiment, the listing of the service providers is based on the geographical location of the user who requested the service. Further, the system may also enable the user to choose the service providers based on the price bid offers and service availability schedules of the service providers.

In an embodiment, the present system utilizes a cloud-based portal which is accessible to the service providers and product suppliers. The cloud-based portal enables the service providers to view and analyze the problem and provide price quotations and availability schedules to the client or user. The present system utilizes machine learning algorithms to learn the patterns of problems and service requests that have a common theme or similar characteristics. Using this attained knowledge, the present system automatically and quickly identifies the problems that have similar characteristics as those that have been previously solved by various service providers. This mechanism of the present system enables the user to quickly get more specific search results and suitable service providers who have successfully solved the identified problem.

Further, the present system automatically identifies various devices or products. Thereafter the present system uses the identified information to automatically identify the suitable service providers who can able to offer repair or maintenance services for that device or product. For example, if the user records a problem about a broken light bulb, the present system is able to identify that the faulty device is a light bulb and automatically limits the service providers listing or search results to only show electricians instead of plumbers.

Furthermore, the present system automatically identifies various models of devices or products. Using this information, it automatically identifies suitable service providers who can able to offer repair or maintenance services for that device or product. Additionally, the present system learns the models of the various devices that the user has previously requested for repair/maintenance services. Using this information, the present system automatically informs the user about the device upgrade options or provides the user with alerts about service schedules as per the device manufacturer's requirements.

The present system automatically filters out illicit content and flag the user to the customer support team for further verification to prevent misuse of the present system. In case any user captures a part of his/her body and tries to upload, then the present system can automatically determine the object and decides not to upload this type of content.

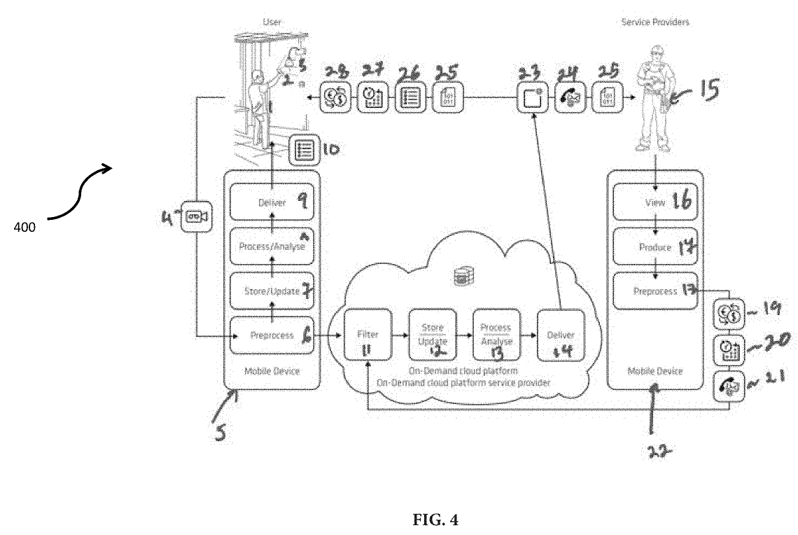

FIG. 4 illustrates an exemplary operational block diagram 400 of the present system and method, in accordance with at least one embodiment. The user 1 points (gesture) his/her mobile device 2 at a broken light (issue) 3 and captures a live video recording 4 of issue 3. The present system by utilizing a software application enables the mobile device 2 that has a camera and a plurality of sensors to automatically recognise the gesture from the user, automatically recognise device or issue that user is capturing a live video 4. Further, the present system transmits the captured data to the on-demand cloud platform. The captured live video of an issue in a file format is analysed and processed in conjunction with the mobile device and the on-demand cloud platform.

The video file is pre-processed 6 by mobile device processors and sensors 5 for transmitting to the on-demand cloud platform or to be processed by the mobile device in the event of limited network bandwidth access. In the event of limited network bandwidth to transmit file to video file to the on-demand cloud platform, the present system stores 7 the captured video file in mobile device storage. The system automatically syncs with the on-demand cloud platform once a reliable network bandwidth is established. Then the system process and analyse 8 the captured video file. Further, the present system transmits 9 the processed data to mobile device input/output interface.

The system then displays 10 to the user the listings of available service providers who can provide service for the issue that has been captured by the user. Further, the system transmits the pre-processed file to the on-demand cloud-computing platform 11. The present system ensures that the transmitted file complies with the set-parameters and rules of the on-demand cloud platform. Then the system stores 12 the captured file on cloud platform which is ready for analysis and processing. The system also archives processed files for machine learning capabilities and data analytics 12. Then the system processes and analyses 13 the captured video file. The system transmits the processed data 14 to mobile device input/output interface to the user who submitted a request to a service provider who can provide service or product requested by the user.

Furthermore, the system alerts the service provider 15 about the user request and the captured issue. The system provides the service provider with options on how to receive service requests made by the users. The system automatically determines which service or product supplier should be contacted. This determination is made from the system's automatic device or issues recognition and machine learning capabilities. The service provider may view 16 user issue stored on the on-demand cloud platform. The system enables the service provider to use their mobile device to view the issue.

Then the system enables the service provider to directly contact 17 the user, offer the user a preliminary cost proposal and offer user a preliminary service delivery schedule. The system may use the service provider mobile device 18 to pre-process the data related to contact the user of the issue, offer the user or issue a cost proposal and offer user of issue a service delivery schedule. The system transmits the pre-processed file to the on-demand cloud-computing platform. The system ensures that the transmitted file complies with the set-parameters and rules.

The symbol 19 represents service provider monetary preliminary bid to the user. The symbol 20 represents service provider preliminary service delivery schedule offer to the user. The symbol 21 represents the contact user options available to the service provider. The service provider's mobile device is shown as 22 in the FIG. 4.

The symbol 23 represents the service requests alerts to the service provider. The present system generates the service request alerts. The symbol 24 represents that the user may contact the service or product provider to request the service. The symbol 25 represents that the other information and data system can be presented to the user. The symbol 26 represents the listing of the service provided to user detailing information about available service providers who can provide them with service or product as pertaining to their captured issue. The symbol 27 represents information about the service provider's preliminary service delivery schedule offer to the user. The symbol 28 represents the information about the service provider's preliminary monetary bid offer to the user.

The term “and/or” means that “and” applies to some embodiments and “or” applies to some embodiments. Thus, A, B, and/or C can be replaced with A, B, and C wrote in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

Where the specification claims refer to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

1. A device in a network, comprising:
a non-transitory storage device having embodied therein one or more routines operable to provide a plurality of service providers based on one or more issues received from a user; and
one or more processors coupled to the non-transitory storage device and operable to execute the one or more routines, wherein the one or more routines include:
a computing mobile device configured to capture the one or more issues through a computing device, wherein the computing device captures the issues by at least one of recording a video, taking a picture, writing text, voice recording, and/or a combination thereof;
an upload module configured to upload the captured issues over the network, wherein the one or more issues are pertaining to at least one of a household service, a repairing service, a construction service, an automobile service, a business service, a renovation service and/or a combination thereof;
an analysis module configured to analyze the uploaded issues and further categorize the uploaded issues into a service category, a plurality of service providers and/or a combination thereof;
a display module configured to display the plurality of service providers operating to provide a service related to the issues uploaded by the user, wherein the plurality of service providers are displayed based on a geographical location of the user, further the service providers provide a bid offer and service availability schedule to provide the service; and a selection module configured to select the service provider based on the bid offer and the service availability schedule.

2. The device as claimed in claim 1, wherein the one or more routines comprise a detection module configured to detect one or more items on receiving a pointing gesture from the user through the computing device, wherein the one or more items are selected from at least one of electrical-electronic units, furniture, building infrastructure and/or a combination thereof.

3. The device as claimed in claim 2, wherein the one or more routines comprise a first identification module configured to identify patterns of issues with a common category or a similar characteristic to accurately display a plurality of service providers on identifying similar issues in future.

4. The device as claimed in claim 2, wherein the one or more routines comprise a second identification module configured to identify a plurality of models of the one or more detected items and consequently display a plurality of service providers operating to offer repair or maintenance services of the identified model of the items; a third identification module configured to identify a plurality of device models of the one or more detected items and consequently display a plurality of suppliers to offer a new or upgrade of the identified device model of the items.

5. The device as claimed in claim 1, wherein the one or more routines comprise a determination module configured to determine the service providers frequently preferred by the user and display the plurality of preferred service providers.

6. A method for providing a plurality of service providers based on one or more issues received from a user, the method comprising steps of:
capturing, by one or more processors, the one or more issues through a computing device, wherein the computing device captures the issues by at least one of recording a video, taking a picture, writing text, voice recording, and/or a combination thereof;
uploading, by one or more processors, the captured issues over a network, wherein the one or more issues are pertaining to at least one of a household service, a repairing service, a construction service, an automobile service, a business service, a renovation service and/or a combination thereof;
analyzing, by one or more processors, the uploaded issues and further categorize the uploaded issues into a service category, a plurality of service providers and/or a combination thereof;
displaying, by one or more processors, the plurality of service providers operating to provide a service related to the issues uploaded by the user, wherein the plurality of service providers are displayed based on a geographical location of the user, further the service providers provide a bid offer and service availability schedule to provide the service; and selecting, by one or more processors, the service provider based on the bid offer and the service availability schedule.

7. The method as claimed in claim 6, further comprising the step of detecting, by one or more processors, one or more items on receiving a pointing gesture from the user through the computing device, wherein the one or more items are selected from at least one of electrical-electronic units, furniture, building infrastructure and/or a combination thereof.

8. The method as claimed in claim 6, further comprising the step of identifying, by one or more processors, patterns of issues with a common category or a similar characteristic to accurately display a plurality of service providers on identifying similar issues in future.

9. The method as claimed in claim 6, further comprising the step of identifying, by one or more processors, a plurality of models of the one or more detected items and consequently display a plurality of service providers operating to offer repair or maintenance services of the identified model of the items.

10. The method as claimed in claim 6, further comprising the step of determining, by one or more processors, the service providers frequently preferred by the user and display the plurality of preferred service providers.

11. A system to provide a plurality of service providers based on one or more issues received from a user, the system comprising:
a processor; and
a memory to store machine readable instructions that when executed by the processor cause the processor to:
capture the one or more issues through a computing device, wherein the computing device captures the issues by at least one of recording a video, taking a picture, writing text, voice recording, and/or a combination thereof;
upload the captured issues over a network, wherein the one or more issues are pertaining to at least one of a household service, a repairing service, a construction service, an automobile service, a business service, a renovation service and/or a combination thereof;
analyze the uploaded issues and further categorize the uploaded issues into a service category, a plurality of service providers and/or a combination thereof;
display the plurality of service providers operating to provide a service related to the issues uploaded by the user, wherein the plurality of service providers are displayed based on a geographical location of the user, further the service providers provide a bid offer and service availability schedule to provide the service; and select the service provider based on the bid offer and the service availability schedule.

12. The system according to claim 11, wherein the processor is further configured to detect one or more items on receiving a pointing gesture from the user through the computing device, wherein the one or more items are selected from at least one of electrical-electronic units, furniture, building infrastructure and/or a combination thereof.

13. The system according to claim 11, wherein the processor is further configured to identify patterns of issues with a common category or a similar characteristic to accurately display a plurality of service providers on identifying similar issues in future.

14. The system according to claim 11, wherein the processor is further configured to identify a plurality of models of the one or more detected items and consequently display a plurality of service providers operating to offer repair or maintenance services of the identified model of the items.

15. The system according to claim 11, wherein the processor is further configured to determine the service providers frequently preferred by the user and display the plurality of preferred service providers.
